(19) United States
(12) Patent Application Publication
(10) Pub. No.: US 2025/0157354 A1
(43) Pub. Date: May 15, 2025

(54) VIRTUAL EDUCATIONAL PLATFORM

(71) Applicant: Joseph Montefusco, Fuquay Varina, NC (US)

(72) Inventor: Joseph Montefusco, Fuquay Varina, NC (US)

(21) Appl. No.: 18/321,773

(22) Filed: May 23, 2023

(51) Int. Cl. G09B 7/02

(52) U.S. Cl. CPC G09B 7/00; G06F 16/3329; G06N 5/022; G09B 7/02

(57) ABSTRACT

A computer-implemented method for providing a virtual voice coach including receiving one or more anticipated questions from an instructor device, receiving one or more answers corresponding to the one or more anticipated questions from the instructor device, storing the one or more anticipated questions and the one or more answers on the instructor database, receiving one or more student questions from the one or more student devices, determining a most similar anticipated question of the one or more anticipated questions based on a similarity between each of the one or more student questions to each of the one or more anticipated questions, retrieving the one or more answers from the instructor database based on the most similar anticipated question, returning the one or more answers to the student device, and causing the one or more student devices to play the one or more answers.

### FIELD OF THE INVENTION

This disclosure generally relates to education. Specifically, this disclosure relates to a virtual education platform including a programmable virtual voice coach.

### BACKGROUND

The development of the internet technology has led to the development of distance learning. Nowadays, students can obtain an education online via a computer connected to the internet. Accordingly, students are able to take classes online instead of on a campus and may obtain degrees in almost any subject while living in any corner of the world.

As technology continues to improve, so do the opportunities to improve remote distance education. There are a number of problems associated with the presently existing education platforms. For example, many online courses today may experience high registration rates and comparatively low completion rates. Further, there may be a considerable gap in the interaction between students and teachers compared with traditional physical courses. Accordingly, there currently exists a need for an improved virtual education platform. The invention in the present disclosure is aimed towards solving the above-mentioned problems in part by providing an improved virtual education platform.

Further, distance learning is not limited to higher education scholastic pursuits. Nowadays, people may hire instructors online to teach them a variety of different skills. People may hire a coach to increase their performance in a sport, a cooking instructor to teach them how to cook, a guru to help them practice mindfulness, and the like.

In the E-Sports industry, as well as in other professional sports industries, players seek out coaching services from pros all the time. However, one-on-one sessions with a pro are oftentimes out-of-budget for many players, so the players who want to improve at their game are left unable to afford coaching services. A cheaper alternative may be to buy a pro's e-book that teaches their tactics. However, players may not want to, and may not be able to read a long wordy document complemented by dozens of videos in the middle of a game. The present invention allows players to get constant instant feedback from their favorite coach in the middle of games or practice sessions, without having to pay for a one-off coaching session. Further, the present invention allows players to receive coaching anywhere in the world, at any hour of the day.

Many people today are familiar with virtual assistant technology, such as asking “Siri” or “Alexa” to check the weather or turn off the lights. However, current virtual assistants are built for very simple and small everyday tasks, and are not well adapted as virtual instructors. Virtual assistants are even commonly implemented for providing automated customer service over the phone. Nevertheless, presently existing virtual assistants are adapted for simple questions and answers that don't require in-depth explanations from an expert on a subject matter. Instead, the in-depth technical questions will result in a user being referred to a specific department where a live expert may be able to answer to the question. Currently existing virtual assistants fail to capture the comprehensiveness and unique perspective of authorities. The present invention includes a virtual voice coach programmed to teach, answer student questions, and provide comprehensive explanations to students in the unique teaching style of the student's actual instructor.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

Embodiments of the present invention comprise a computer-implemented digital educational assistance method, with a database system and a user work system and a processing system, comprising the steps: creating an at least one anticipated question by an instructor, creating an at least one answer corresponding to the anticipated question the instructor, storing the at least one anticipated question and the at least one corresponding answer in the database, receiving an at least one student question from a student, comparing the at least one student question to the at least one anticipated question, determining a level of similarity between the at least one student question to the at least one anticipated question, retrieving the at least one answer corresponding to the at least one anticipated question that is most similar to the at least one student question, transmitting the at least one answer to a student computing device, and receiving the at least one answer by the student, wherein the at least one answer transmitted to the student computing device and received by the student is presented in a unique teaching style corresponding to the instructor.

A computer-implemented digital educational assistance system with a database system and a user work system and a processing system and a computer-implemented digital educational assistance method.

One objective of the present invention is to improve the quality of distance education and distance education technology and improve the way students are able to self-study outside of the classroom.

Another object of the present invention is to strengthen the relationship between coaches and athletes, students and instructors, trainees and trainers, employees and employers, and the like.

Another object of the invention is to provide a credible source for information, wherein the credible source of information is a student's own instructor.

Another object of the present invention is to introduce the tremendous scaling opportunities to coaching and consulting businesses, since such businesses are no longer constrained by the number of coaches/instructors available on their staff.

### BRIEF DESCRIPTION OF THE DRAWINGS

The following drawings are intended to serve as exemplary embodiments of the features disclosed in the present disclosure.

FIG. 1 is a diagram illustrating an exemplary computer system for providing a virtual education platform.

FIG. 2A is a flowchart illustrating an exemplary method of programming a virtual voice coach.

FIG. 2B is a flowchart illustrating an exemplary computer-implemented method of providing a virtual education platform.

FIG. 3 is a diagram illustrating an exemplary computing device configured to perform the functions of the present invention.

FIG. 4 is a block diagram illustrating depicting an exemplary client/server system which may be used by an exemplary web-enabled/networked embodiment of the present invention.

### DETAILED DESCRIPTION OF DRAWINGS

The description of illustrative embodiments according to principles of several illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits are illustrated by reference to certain exemplified embodiments and may not apply to all embodiments.

Accordingly, the invention expressly should not be limited to such exemplary embodiments illustrating some possible non-limiting combination of features that may exist alone or in other combinations of features; the scope of the claimed invention being defined by the claims appended hereto.

This disclosure describes the best mode or modes of practicing the invention as presently contemplated. This description is not intended to be understood in a limiting sense but provides an example of the invention presented solely for illustrative purposes by reference to the accompanying drawings to advise one of ordinary skill in the art of the advantages and construction of the invention. In the various views of the drawings, like reference characters designate like or similar parts.

The present invention includes a “Virtual Voice Coach” comprising voice artificial intelligence to be used by authorities on specific subject matters and students seeking to learn from those authorities. The present invention will allow an authority to easily communicate (without having to be physically present) their comprehensive unique teachings and perspectives to trainees, anytime and anywhere. Specifically, the Virtual Voice Coach is adapted for relations involving teacher-student interaction, coach-athlete interaction, employer-employee interaction, and similar types of relationships. There are key differences between the present invention and other virtual assistant software, including but not limited to: the intention of the software, accessibility of the software, the ease of use for the instructor as well as the student, and the customizability of the software.

It is contemplated that the present invention could not be performed by the human mind alone, and the present invention is likewise tied to computer technology, such as the computer technology implemented in the exemplary embodiments disclosed in the present disclosure. Ordinarily, an instructor is limited by space and time in their ability to teach students. For example, an instructor could not provide an answer to a student residing in New York and at the same time provide an answer to a student residing in Tokyo. Further, a human instructor is also limited by the amount of questions they may be able to answer in a given session. For example, it would not be possible for an instructor to answer 1,000 student questions in a single one-hour session. However, the present invention allows students from all over the world to simultaneously receive instruction at any and all times of day. Accordingly, that would not be possible without the computer technology disclosed in the present disclosure.

The intention of the present invention is to allow subject matter authorities to anticipate questions they would get from students, trainees, employees, and the like, by inputting their own questions and explanations in a software application configured to deploy the Virtual Voice Coach. For example, imagine that a 3^{rd} grade math teacher is teaching her students multiplication. A teacher's style of teaching math to kids nowadays is much different than the methods that were once taught. If a kid cannot figure out the math homework on their own, they often then ask their parents at home for help. Although the parents know how to do multiplication, they may not know same methodology or approach to multiplication that is being taught by their kid's teacher. The present invention is aimed towards alleviating the above-mentioned scenario, by providing the student with a Virtual Voice Coach configured to answer questions and provide explanations to the student in the teacher's own unique teaching style.

The present invention allows teachers to easily input their own voice commands through the software application. So, if the kid forgets what his math teacher taught them that day, they can conveniently ask their teacher through the application a specific question and instantaneously, automatically, receive auditory and visual feedback from their teacher in a matter of seconds or less.

Ordinarily, students may turn to alternative sources to fill in the gaps of their understanding of a certain subject. For example, it is common for students to turn to YouTube, Google, or any number of paid homework help online subscriptions. However, it is nevertheless impossible for YouTube, Google, or any other website to be able to provide an answer for a student that captures the unique explanation and teaching style of one's own teacher. Further, the more specialized or advanced a particular course is, the more difficult it is to find the right information online, especially for niche subject matters.

Further, teachers often may upload their lecture videos online for students to be able to access and watch from home. However, even if a teacher does happen to upload lecture videos online, it takes too much time for a student carefully skimming through each video to discover the answer to their particular question, thus making difficult if not impossible to study and learn efficiently. For example, a student may be studying for a stressful final exam and has just a few questions to ask their teacher, but their teacher is too busy with other students during finals week that he is not able to respond to the student's particular questions. That teacher may have uploaded all the lecture videos online, but it is not feasible for a student to scroll and search through nearly a hundred videos to find an answer to a specific question. The present invention allows the student to receive instant feedback from their teacher for any question, even if the teacher is not physically available. Additionally, the present invention saves teachers an enormous amount of time ordinarily spent on repeating the same answers to the same commonly asked questions. This allows teachers with busy schedules to focus on other tasks they may need to complete, such as grading papers, or and also gives teachers more free time to themselves, effectively reducing teaching fatigue they may otherwise experience.

All of the software features described are adapted specifically to the authority and end-user, making the application easy for both the authority and end-user to use. Further, the user-friendly programmable nature of the present invention accounts for an ever-changing educational landscape allows an authority to update and create new voice commands at any time.

The following disclosure includes systems and methods of virtual education including a programmable virtual voice coach application. In some embodiments, the present invention is developed in part with the use of a voice application developer kit. Further, in one embodiment, SiriKit™ is used in part to develop the present invention. It is contemplated that any suitable developer kit may be utilized to implement the present invention.

One objective of the present invention is to improve the quality of distance education and distance education technology and improve the way students are able to self-study outside of the classroom.

Another object of the invention is to provide a credible source for information, wherein the credible source of information is a student's own instructor.

Another object of the present invention is to strengthen the relationship between coaches and athletes, students and instructors, trainees and trainers, employees and employers, professionals and clients, and the like.

Another object of the present invention is to introduce the tremendous scaling opportunities to coaching and consulting businesses, since such businesses are no longer constrained by the number of coaches/instructors available on their staff.

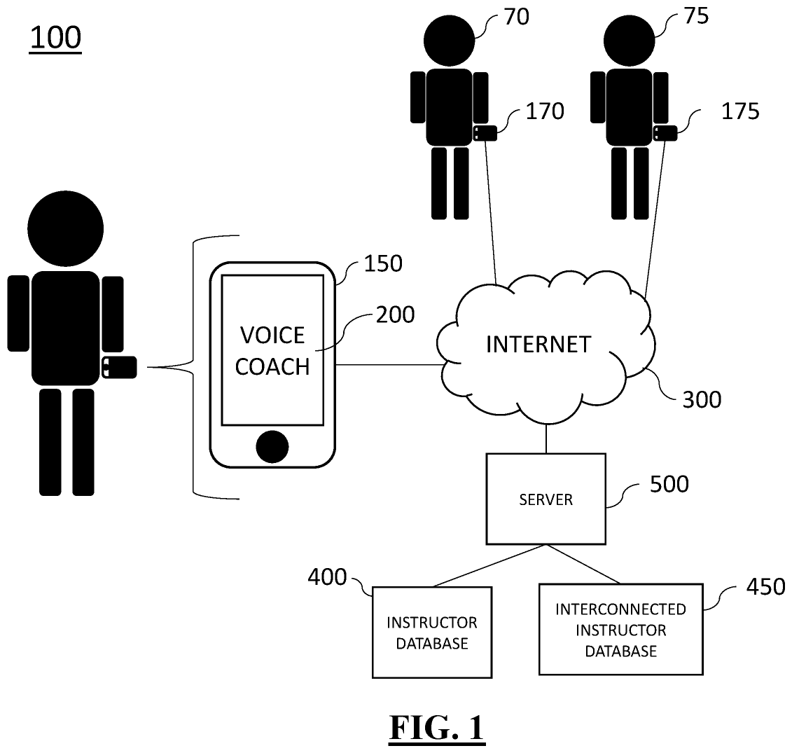

FIG. 1 is a diagram illustrating an exemplary computing system configured for performing the functions of the present invention. The computer system 100 includes a student computing device 150 configured to deploy a Virtual Voice Coach mobile application 200. The student computing device 150 may be used by a student 50 in order to access the Virtual Voice Coach application described in greater detail below. The computer system 100 further includes at least one instructor computing device 170 which may be used by an instructor 70 in order to record and input their own lessons, question-answer pairs, reviews, assessments, and the like, in their own unique teaching style. The computer system 100 is shown including another instructor computing device 175 being used by another instructor 75. Although only 2 instructors 170, 175 are shown, it is contemplated that any number of instructors and/or students may use the system 100 simultaneously. The system 100 further includes an instructor database 400 configured to store all teaching related information an at least one given instructor. In some embodiments, the system 100 further includes an interconnected instructor database 450 that is configured to store all teaching related information from all instructors using the platform, allowing students and/or instructors to retrieve teaching information that may not be available in the individual instructor database 400

In some embodiments, the system 100 may be configured to communicate with the internet 300. In some embodiments, the system 100 may include a web server 500 configured to communicatively interconnect to one or more student devices 150, and to one or more instructor devices 170, 175 over the internet 300. The web server includes 500 may include, a memory having instructions stored thereon, and a processor configured to execute the instructions on the memory causing the web server 500 to deploy the Virtual Voice Coach application 200.

The Virtual Voice Coach application 200 is configured to perform a variety of functions, described in greater detail herein the present disclosure. In one embodiment, an instructor 70 uses an instructor version of the application 200 while a student 50 uses a student version of the application 200. In some other embodiments, both the instructor 70 and the student 50 use the same version of the application. In some embodiments, instructors and students have different levels of access to the application and different permissions to access different features on the application.

In the preferred embodiment, the instructor 70 uses the application to input lessons, explanations, commonly asked questions, key concepts, as well as other types of information useful to promote learning. Further, the instructor is able to record his own unique teaching style using the application.

Each instructor maintains their own unique teaching style and perspectives when teaching a particular subject or course. A teaching method comprises the principles and methods used by teachers to enable student learning. These strategies may be determined partly on subject matter to be taught and partly by the nature of the learner. The most basic teaching method is explanation. The role of an explanation is to make clearer the meaning of an concept and the goal of explanation is to manifest comprehension of a particular subject. However, even when it comes to explanation, the specific manner by which teachers provide explanations to students may vary widely from teacher to teacher.

In some embodiments, the present invention includes an interconnected instructor database comprising information stored across all individual instructor databases. It is contemplated that an instructor may not always be able to anticipate every question that a student may ask. Ordinarily, if a student was to ask the virtual instructor a question that the actual instructor has not programmed, it is possible that the virtual instructor would be unable to provide an answer. However, the present invention includes the ability to share information across instructor database, in order to fill any possible gaps in teaching a subject. For example, Math Teacher A creates Question Bank A, wherein Question Bank A comprises question-answer pairs programmed by Math Teacher A, while Math Teacher B creates Question Bank B, wherein Question Bank B comprises question-answer pairs programmed by Math Teacher B. If a student asked a question to Math Teacher A that Math Teacher A has not programmed, then ordinarily there would be no corresponding answer available to transmit to the student. However, the present invention includes creating an interconnected database comprising information from all individuals databases, configured to send and retrieve information to and from all said individual database. To expand the previous example, using the present invention, both Math Teacher A and Math Teacher B have access to Question Bank AB, wherein question Bank AB comprises all the question-answer pairs from Question Bank A and Question Bank B. Thus, if the student asks a question to Math Teacher A that Math Teacher A has not programmed, the correct answer can still be retrieved from Question Bank AB, given that the question-answer pair exists somewhere on at least one other individual database.

Further, in some embodiments, answers to questions from other individual databases may be transformed to answers that would correspond to an instructor's unique teaching style. For example, if a student asks a question to virtual Math Teacher A that Math Teacher A has not programmed, the correct answer retrieved to the question will not be outputted in the teaching style of the original instructor that programmed the question, but instead will now be outputted in the teaching style of the virtual instructor that has been asked the question.

For the purposes of the example embodiment of FIG. 1, various functions are shown to be performed on different programmable computing devices that communicate with each other over the Internet. These computing devices may include smartphones, laptop computers (not shown), tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

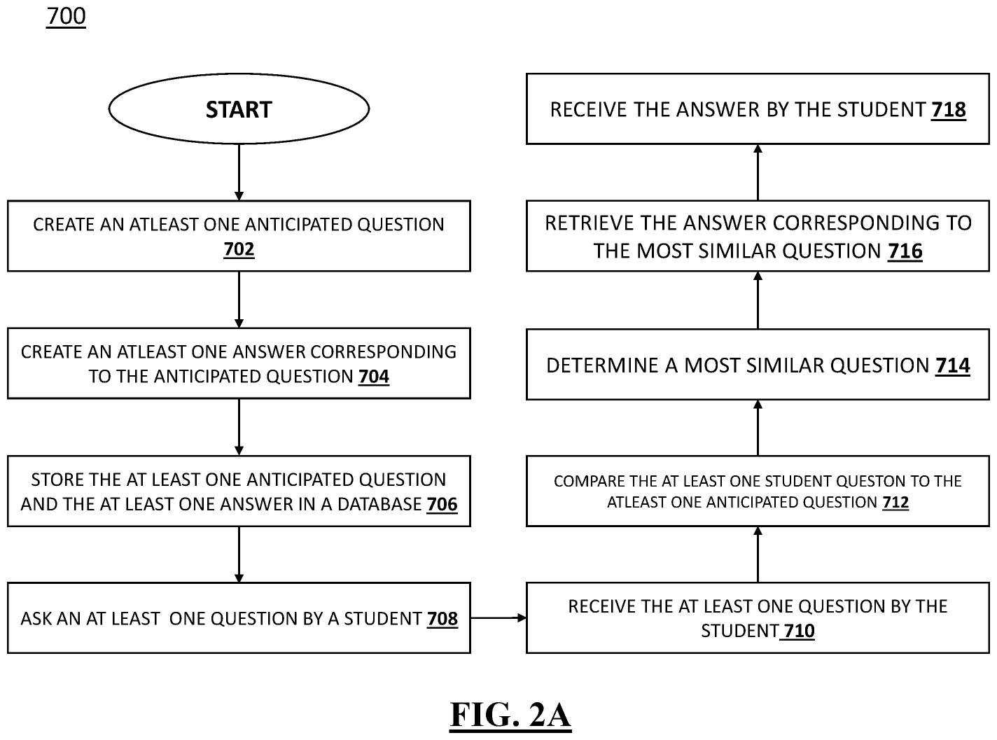

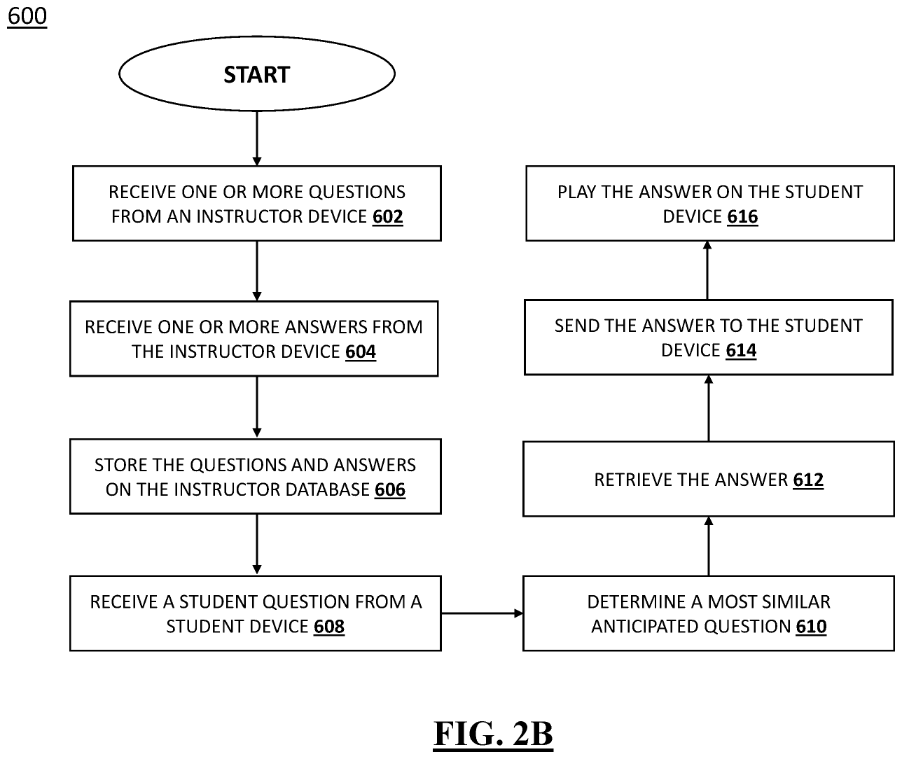

FIG. 2A is a flowchart illustrating an exemplary method of virtual instruction. The method generally comprises the following steps: creating an at least one anticipated question by an instructor, creating an at least one answer corresponding to the anticipated question the instructor, storing the at least one anticipated question and the at least one corresponding answer in a database, receiving an at least one student question from a student, comparing the at least one student question to the at least one anticipated question, determining a level of similarity between the at least one student question to the at least one anticipated question, retrieving the at least one answer corresponding to the at least one anticipated question that is most similar to the at least one student question, transmitting the at least one answer to a student computing device in a unique teaching style corresponding to the instructor, and receiving the at least one answer by the student.

With continued reference to FIG. 2, first, at step 702, an instructor creates an at least one instructor question. The instructor question may be any time of question, typically of a type of question that is usually asked by a student taking the instructor's particular course. For example, a math instructor may create the question, “How do you find the area of a triangle?”

Next, at step 704, the instructor creates an answer for the question. For example, the answer to the exemplary question may be: “one half base times height”. However, the answer may be in a different format as well. For example, the instructor may instead create the answer to the question to be: “Use Heron's Formula”, and then proceed to explain how to use said formula. Although both answers are technically correct, it may be the case that one answer is easier for students to understand than the other, and/or that one answer is easier for the instructor to instill into students than the other.

The instructor is free to create any sort of answer in their own unique teaching style to any question that they create. One advantage of recording an instructor's unique teaching style is that it allows the student to receive the same quality of experience as if the student was asking the question to the instructor in a classroom setting.

Further, in some embodiments, the instructor may record multiple correct answers to the same question. Providing multiple answers increases the likelihood that a student will understand the subject matter being taught. If the student is not satisfied or does not necessarily understand the first explanation, the student may ask: “Explain this to me in a different way”, and the Virtual Voice Coach may provide a second answer. If the second answer is not yet satisfactory, the student can keep asking for a different explanation until the student fully grasps the concept(s) at hand.

It is contemplated that the instructor may unintentionally omit some possible student questions that a student may want to ask the instructor. However, it may also be the case that a different instructor teaching the same course has provided an answer to that question that the first instructor had not. In such a circumstance, the correct answer to the student's question may still be retrieved from the second instructor teaching the same course.

Next, at step 706, the anticipated question and the corresponding answer are stored in a database.

Next, at step 708, a student asks the Virtual Voice Coach a question. Accordingly, at this step a student asks the Virtual Voice Coach a question that they may need an explanation or clarification for.

Next, at step 710, an at least one student question from a student is received from a student.

Next, at step 712, the at least one student question is compared to one or more anticipated questions created by the instructor saved on the database. Accordingly, the question is compared to all of the questions that the instructor has created and stored in the database, in order to find the anticipated question that most closely resembles the student question.

Next, at step 714, a level of similarity between the student question and one or more anticipated questions is determined. Accordingly, each anticipated question created by the instructor saved on the database is assigned a similarity value. Further, the anticipated question with the highest similarity value is determined to be the most similar question to the student question.

Next, at step 716 the answer corresponding to the most similar question the student question is retrieved from the database and transmitted to a student computing device possessed by the student.

Finally, at step 718, the at least one answer is received by the student. A key aspect of the present invention is that the answer received by the student is in the unique teaching style of their instructor. The term “teaching style” refers to any aspect related to the instructor's own way of educating, communicating information, and explaining concepts to a student, including but not limited to: tone of voice, inflection, pitch, duration, intensity, timbre, word choice, use of humor, use of metaphors, mannerisms, and so forth.

It is to be understood that steps 714 and 716 may be performed in part by using at least one Natural Language Processing (“NLP”) algorithm. Further, the algorithm may be used to determine the statistical probability that a student question has the same meaning as an anticipated question that has been created by the instructor. For example, if a student asks the Virtual Voice Coach “What is the area of a rectangle?”, and the instructor has created and stored the questions, “How do you find the area of a rectangle?” and “How do you find the area of a triangle?”, then the algorithm is able to determine that “What is the area of a rectangle?” has the same meaning as “How do you find the area of a rectangle?”, even though the two are not identical to each other.

The present invention may further comprise of at least one machine learning technique that may aid in determining recognizing student questions, generating answers to questions, transforming answers into the unique teaching style of an instructor, generating additional anticipated questions based on commonly asked student questions, and more. Further, the machine learning technique may include the use of interpolation. Interpolation is a type of estimation, a method of constructing new data points based on the range of a discrete set of known data points. Furthermore, the present disclosure contemplates the use of at least one or more supervised learning techniques, unsupervised learning techniques, and any combination thereof. It should be understood by one of ordinary skill in the art that the at least one machine learning algorithm may include, but is not limited to: Neural-Networks, Deep Neural Networks (“DNN”), Markov Chain Monte Carlo Neural Networks (“MCMC”), Generative Adversarial Networks (“GAN”), Bayesian networks, Transformer Networks, and any other methods known to one of ordinary skill in the art have herein been considered. The term “machine learning” should not be construed by one of ordinary skill in the art to be limiting the scope of the invention disclosed in the present disclosure. The terms “machine learning”, “artificial intelligence”, “neural-network”, may all be used interchangeably without departing from the scope and spirit of the invention disclosed in the present disclosure.

In some embodiments, the virtual instructor is configured to perform review sessions with students. For example, the instructor may ask a question, which a user may then answer. If the student provides the correct answer, the instructor will then explain why the answer is correct, provide a follow up question to make sure that the student understands why the question is correct, and/or provide a new question from a different topic to ask the student. If the student provides an incorrect answer, the instructor will then explain why the answer is incorrect.

In some embodiments, the correct answer to a question is translated into the student's native language. If a non-English speaker would like to take a course that is only offered in English, the Virtual Voice Coach may still be able to provide the correct answers and explanations to the student in their preferred language.

FIG. 2B is another diagram illustrating an exemplary method of virtual instruction. The method generally comprises the following steps: receiving one or more anticipated questions from an instructor device, receiving one or more answers corresponding to the one or more anticipated questions from the instructor device; storing the one or more anticipated questions and the one or more answers on the instructor database; receiving one or more student questions from the one or more student devices; determining a most similar anticipated question of the one or more anticipated questions based on a similarity between each of the one or more student questions to each of the one or more anticipated questions; retrieving the one or more answers from the instructor database based on the most similar anticipated question; returning the one or more answers to the student device; and causing the one or more student devices to play the one or more answers.

In some embodiments, the method 600 depicted by FIG. 2B comprises a computer-implemented method for providing a virtual education platform and virtual voice coach using a web-server, the web server configured to communicatively interconnect to one or more student devices, and to one or more instructor devices over the internet, the web server comprises a searchable instructor database, a memory having instructions stored thereon, and a processor configured to execute the instructions on the memory causing the web server to perform the method 600.

With continued reference to FIG. 2B, first at step 602, one or more anticipated questions are received from the instructor device. The anticipated questions may be any questions that the instructor using the instructor devices creates, that the instructor anticipates may be potentially asked by a student.

Next, at step 604, one or more answers corresponding to the one or more anticipated questions are received from the instructor device. The answers may include answers that the instructor using the instructor device has created, to answer the questions that the instructor has created in step 602. In some embodiments, one answer is provided per each anticipated question. In other embodiments, more than one answer is provide per each anticipated question. It is contemplated that more than one answer may help a potential student to better understand a concept. Further, a key aspect of the present invention is that the answer to the question is characteristic of the instructor's unique teaching style.

Next, at step 606, the one or more anticipated questions and the one or more answers are stored on the instructor database.

Next, at step 608, one or more student questions are received from the one or more student devices being used by the student(s).

Next, at step 610, a most similar anticipated question of the one or more anticipated questions based on a similarity between each of the one or more student questions to each of the one or more anticipated questions is determined. The most similar anticipated question may be determined by any known data comparison technique.

In some embodiments, the method may include determining a level of similarity between each of the one or more student questions to the one or more anticipated questions, comparing the level of similarity of the student question against a threshold similarity, and upon a determination that the level of similarity does not meet the threshold similarity, storing the student question into the instructor database as an unanticipated student question, and sending a notification to the instructor device to create an unanticipated student question answer corresponding to the unanticipated student question. The instructor may then create and store an answer to the unanticipated student question on the student instructor database. It is contemplated that the threshold similarity may be any value corresponding to between 0% and 100% similarity.

In some embodiments, a notification may be sent to the student device once the instructor has answered the unanticipated student question, indicating to the student that the instructor has answered their question. It is contemplated that sending a notification to the student once the instructor has answered their question fosters a better connection between the student and instructor. Instead of the student feeling as if they are interacting with a purely automated system, the student may appreciate receiving personalized feedback from their instructor, and likewise may not feel as if they are interacting with a cold distant robot.

Next, at step 612, the answer that corresponds to the most similar anticipated question is retrieved from the instructor database and transmitted to the one or more student devices.

Finally, at step 614, the answer is played on the one or more student devices.

In some embodiments, the virtual education platform may include a group study embodiment. In said group study embodiment, one student question may be asked to the virtual instructor, and the same answer may be played to a plurality of student devices. Accordingly, a group of students may study together and receive the same feedback from the virtual voice coach simultaneously.

In some embodiments, the virtual voice coach may be adapted for providing professional feedback. For example, a client may call a lawyer to ask a question, but the lawyer may be unavailable or talking with another client at that time. Nevertheless, the client may have a question such as “how long after I have filed a provisional patent application do I have to file a non-provisional patent application?” In response, the virtual voice coach may reply “you have 1 year from the filing date of your provisional patent application to file a non-provisional patent application for the same invention.”

More broadly, the virtual voice coach may be adapted for any industry where a client may be seeking immediate professional feedback. Due to a limited amount of time, a single professional may be unable to be available for all of their clients in a given day. To address this problem, the present invention may provide professional feedback in lieu of the professional. It is contemplated that certain professionals may spend an excessive amount of time on the phone with clients rather that takes away from their time to produce work products. The present invention gives professionals more freedom to work on assignments, while still providing answers to clients when they may not be available to do so.

While the term “student” is used throughout the present disclosure, it should be understood that the terms “student”, “trainee”, “employee”, “athlete”, “player”, “client”, “user”, “end-user”, and the like may all be used interchangeably without departing from the spirit and scope of the present invention. It is to be understood that “student” and like said terms denote the person who is using the Virtual Voice Coach to learn.

While the term “instructor” is used throughout the present disclosure, it should be understood that the terms “instructor”, “trainer”, “employer”, “coach”, “pro”, “authority”, “professional”, and the like may all be used interchangeably without departing from the spirit and scope of the present invention. It is to be understood that “instructor” and like said terms denote the person who is programming the Virtual Voice Coach with questions and answers corresponding to those questions.

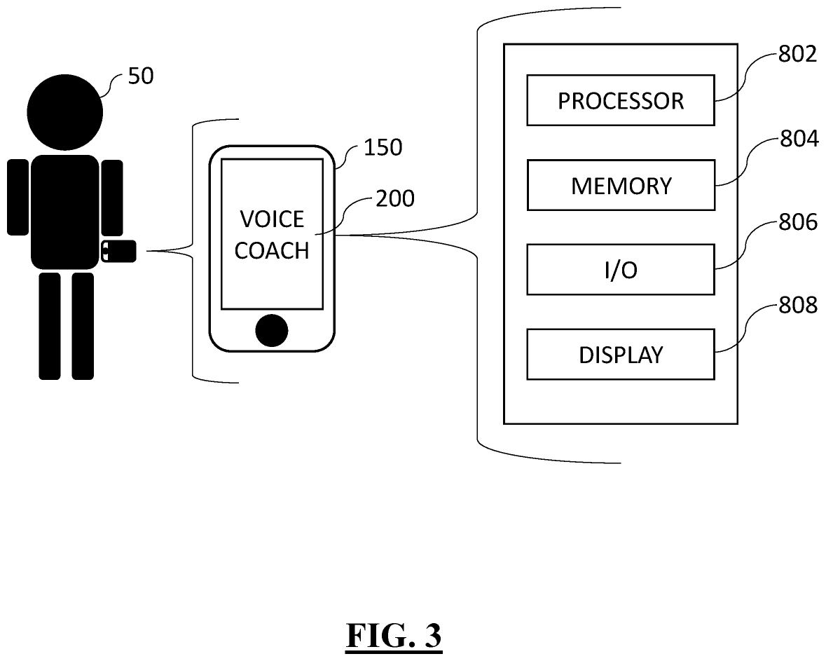

FIG. 3 illustrates a computing device 800 adapted according to certain embodiments of the server and/or the user interface device. The processor 802 is coupled to a system bus. The processor 802 may be a general purpose CPU or microprocessor, graphics processing unit (“GPU”), and/or microcontroller. The present embodiments are not restricted by the architecture of the processor 802 so long as the processor 802, whether directly or indirectly, supports the operations as described herein. The processor 802 may execute the various logical instructions according to the present embodiments.

The computer system 800 may also include an input/output (I/O) adapter 806, and a display adapter 808, as well as other adapters, such as a communications adapter and/or a user interface adapter. The I/O adapter 806 and/or the user interface adapter may, in certain embodiments, enable a user to interact with the computer system 800. In a further embodiment, the display adapter 808 may display a graphical user interface (GUI) associated with a software or web-based application comprising a display device of the computing device 150, such as a monitor or touch screen.

The I/O adapter 806 couples to one or more I/O devices. For example, the I/O device may be a microphone configured to receive a student question. As another example, the device may be a display configured to display a Virtual Voice Coach.

The I/O adapter 806 may couple one or more storage devices 804, such as one or more of a hard drive, a solid state storage device, a flash drive, a compact disc (CD) drive, a floppy disk drive, and a tape drive, to the computer system 800. According to one embodiment, the data storage 804 may be a separate server coupled to the computer system 800 through a network connection to the I/O adapter 806. The communications adapter may be adapted to couple the computer system 800 to the network, which may be one or more of a LAN, WAN, and/or the Internet.

The I/O adapter 806 couples to user input devices, such as a keyboard, a pointing device, and/or a touch screen to the computer system 800. The keyboard may be an on-screen keyboard displayed on a touch panel. Additional devices (not shown) such as a camera, microphone, video camera, three-dimensional camera, virtual reality camera, and the like may be coupled to the I/O adapter 806. Any of the devices 806 may be physical and/or logical.

The applications of the present disclosure are not limited to the architecture of computer system 800. Rather the computer system 800 is provided as an example of one type of computing device that may be adapted to perform the functions of a server and/or the user interface device. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

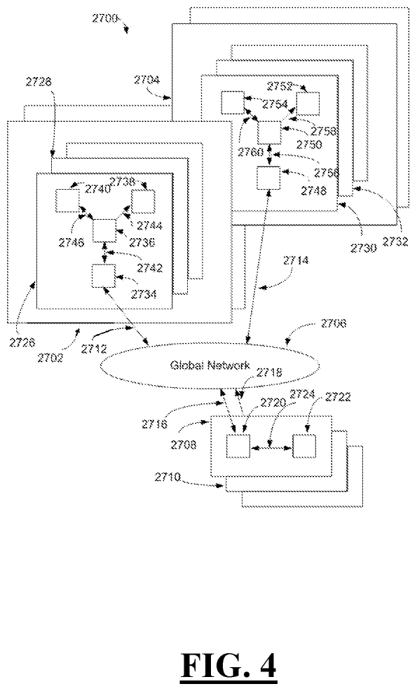

FIG. 4 is a block diagram illustrating depicting an exemplary client/server system which may be used by an exemplary web-enabled/networked embodiment of the present invention.

A communication system 2700 includes a multiplicity of clients with a sampling of clients denoted as a client 2702 and a client 2704, a multiplicity of local networks with a sampling of networks denoted as a local network 2706 and a local network 2708, a global network 2710 and a multiplicity of servers with a sampling of servers denoted as a server 2712 and a server 2714.

Client 2702 may communicate bi-directionally with local network 2706 via a communication channel 2716. Client 2704 may communicate bi-directionally with local network 2708 via a communication channel 2718. Local network 2706 may communicate bi-directionally with global network 2710 via a communication channel 2720. Local network 2708 may communicate bi-directionally with global network 2710 via a communication channel 2722. Global network 2710 may communicate bi-directionally with server 2712 and server 2714 via a communication channel 2724. Server 2712 and server 2714 may communicate bi-directionally with each other via communication channel 2724. Furthermore, clients 2702, 2704, local networks 2706, 2708, global network 2710 and servers 2712, 2714 may each communicate bi-directionally with each other.

In one embodiment, global network 2710 may operate as the Internet. It will be understood by those skilled in the art that communication system 2700 may take many different forms. Non-limiting examples of forms for communication system 2700 include local area networks (LANs), wide area networks (WANs), wired telephone networks, wireless networks, or any other network supporting data communication between respective entities.

Clients 2702 and 2704 may take many different forms. Non-limiting examples of clients 2702 and 2704 include personal computers, personal digital assistants (PDAs), cellular phones and smartphones.

Client 2702 includes a CPU 2726, a pointing device 2728, a keyboard 2730, a microphone 2732, a printer 2734, a memory 2736, a mass memory storage 2738, a GUI 2740, a video camera 2742, an input/output interface 2744 and a network interface 2746.

CPU 2726, pointing device 2728, keyboard 2730, microphone 2732, printer 2734, memory 2736, mass memory storage 2738, GUI 2740, video camera 2742, input/output interface 2744 and network interface 2746 may communicate in a unidirectional manner or a bi-directional manner with each other via a communication channel 2748. Communication channel 2748 may be configured as a single communication channel or a multiplicity of communication channels.

CPU 2726 may be comprised of a single processor or multiple processors. CPU 2726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 2736 is used typically to transfer data and instructions to CPU 2726 in a bi-directional manner. Memory 2736, as discussed previously, may include any suitable computer-readable media, intended for data storage, such as those described above excluding any wired or wireless transmissions unless specifically noted. Mass memory storage 2738 may also be coupled bi-directionally to CPU 2726 and provides additional data storage capacity and may include any of the computer-readable media described above. Mass memory storage 2738 may be used to store programs, data and the like and is typically a secondary storage medium such as a hard disk. It will be appreciated that the information retained within mass memory storage 2738, may, in appropriate cases, be incorporated in standard fashion as part of memory 2736 as virtual memory.

CPU 2726 may be coupled to GUI 2740. GUI 2740 enables a user to view the operation of computer operating system and software. CPU 2726 may be coupled to pointing device 2728. Non-limiting examples of pointing device 2728 include computer mouse, trackball and touchpad. Pointing device 2728 enables a user with the capability to maneuver a computer cursor about the viewing area of GUI 2740 and select areas or features in the viewing area of GUI 2740. CPU 2726 may be coupled to keyboard 2730. Keyboard 2730 enables a user with the capability to input alphanumeric textual information to CPU 2726. CPU 2726 may be coupled to microphone 2732. Microphone 2732 enables audio produced by a user to be recorded, processed and communicated by CPU 2726. CPU 2726 may be connected to printer 2734. Printer 2734 enables a user with the capability to print information to a sheet of paper. CPU 2726 may be connected to video camera 2742. Video camera 2742 enables video produced or captured by user to be recorded, processed and communicated by CPU 2726.

CPU 2726 may also be coupled to input/output interface 2744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 2726 optionally may be coupled to network interface 2746 which enables communication with an external device such as a database or a computer or telecommunications or internet network using an external connection shown generally as communication channel 2716, which may be implemented as a hardwired or wireless communications link using suitable conventional technologies. With such a connection, CPU 2726 might receive information from the network, or might output information to a network in the course of performing the method steps described in the teachings of the present invention.

As used throughout this application, a “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128s or 256 bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Python, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and

“computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

In some aspects, clients or servers (or both) may make use of one or more specialized services or appliances that may be deployed locally or remotely across one or more networks. For example, one or more databases in either local or remote storage may be used or referred to by one or more aspects. It should be understood by one having ordinary skill in the art that databases in storage may be arranged in a wide variety of architectures and use a wide variety of data access and manipulation means. For example, in various aspects one or more databases in storage may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

Accordingly, the invention expressly should not be limited to such exemplary embodiments illustrating some possible non-limiting combination of features that may exist alone or in other combinations of features; the scope of the claimed invention being defined by the claims appended hereto.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method, the method comprising the steps of:
creating an at least one anticipated question by an instructor;
creating an at least one answer corresponding to the anticipated question the instructor;
storing the at least one anticipated question and the at least one corresponding answer in a database;
receiving an at least one student question from a student;
comparing the at least one student question to the at least one anticipated question;
determining a level of similarity between the at least one student question to the at least one anticipated question;
retrieving the at least one answer corresponding to the at least one anticipated question that is most similar to the at least one student question;
transmitting the at least one answer to a student computing device; and
receiving the at least one answer by the student.

2. The method of claim 2, wherein the at least one answer transmitted to the student computing device and received by the student presented in a unique teaching style corresponding to the instructor

3. A remote education computing system, the education system comprising:
an instructor computing device, the device comprising an instructor processor, an instructor memory, and an instructor set of instructions stored on the instructor memory, that when executed by the instructor processor, cause the instructor computing device to:
store an at least one anticipated question and an at least one corresponding answer on a database;
receive an at least one student question from a student computing device;
compare the at least one student question to the at least one anticipated question;
determine a level of similarity between the at least one student question to the at least one anticipated question;
retrieve the at least one answer corresponding to the at least one anticipated question that is most similar to the at least one student question based on the level of similarity; and
transmit the at least one answer to a student computing device.

4. The system of claim 3, wherein the instructor computing device is further configured to reproduce the at least one answer to in a unique teaching style corresponding to the instructor.

5. A computer-implemented method for providing a virtual education platform and virtual voice coach using a web-server, the web server configured to communicatively interconnect to one or more student devices, and to one or more instructor devices over the internet, the web server comprises a searchable instructor database, a memory having instructions stored thereon, and a processor configured to execute the instructions on the memory causing the web server to perform the method, the method comprising:
receiving one or more anticipated questions from an instructor device;
receiving one or more answers corresponding to the one or more anticipated questions from the instructor device;
storing the one or more anticipated questions and the one or more answers on the instructor database;
receiving one or more student questions from the one or more student devices;
determining a level of similarity between each of the one or more student questions to each of the one or more anticipated questions;
determining a most similar anticipated question of the one or more anticipated questions based on the level of similarity between each of the one or more student questions to each of the one or more anticipated questions;
retrieving the one or more answers from the instructor database based on the most similar anticipated question;
returning the one or more answers to the student device; and
causing the one or more student devices to play the one or more answers.

6. The computer-implemented method of claim 5, wherein the one or more answers comprises a unique teaching style of an instructor providing the one or more answers utilizing the instructor device.

7. The computer-implemented method of claim 5, further comprising, upon a determination that the level of similarity does not meet a threshold similarity, retrieving an alternate different instructor answer stored on an interconnected instructor database.

8. The computer-implemented method of claim 5, further comprising receiving a request for an alternative explanation from the one or more student devices and returning an alternative explanation to the one or more student devices.

9. The computer-implemented method of claim 5, the method further comprising, prior to returning the answer to the student device, converting the one or answers to a preferred language of the one or more students.

10. The computer-implemented method of claim 5, the method further comprising, upon a determination that the level of similarity does not meet a threshold similarity, storing the at least one student question into the instructor database as an unanticipated student question.

11. The computer-implemented method of claim 10, the method further comprising sending a notification to the instructor device that a new unanticipated student question has been entered into the instructor database.

12. The computer-implemented method of claim 11, the method further comprising sending a notification to the student device that the new unanticipated student question has been answered once a corresponding answer to the new unanticipated student question has been received from the instructor device and stored in the instructor database.
